(19) United States
(12) Patent Application Publication
(10) Pub. No.: US 2006/0031514 A1
(43) Pub. Date: Feb. 9, 2006

(54) Initiating communication sessions from a first computer network to a second computer network

(75) Inventor: Laurent Pierre Francois Bousis, Leuven (BE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKLE PHILIPS ELECTRONICS, N. V., EINDHOVEN (NL)

(21) Appl. No.: 10/527,357

(22) PCT Filed: Aug. 4, 2003
(86) PCT No.: PCT/IB03/03426

§ 371 Date: Mar. 10, 2005

(30) Foreign Application Priority Data
Sep. 16, 2002 (EP) 02078797.4

(51) Int. Cl. G06F 15/16

(52) U.S. Cl. 709/227

(57) ABSTRACT

The invention relates to a method, an interface device and system of computing devices for enabling start of sessions from a first to a second network and to a computer program product and computer program element performing the method. A name query is received (44) in an interface device from a first computational device communicating via the first network concerning a second device in the second network. The query includes a first address (AZ) for the first device in a first addressing realm of the first network. The gateway binds (50) the first address to a second address (AY) in a second addressing realm of the second network belonging to a second device and answers (52) the query with a message comprising a third address (AG) in the first addressing realm belonging to the gateway. The interface device is preferably a gateway provided between a residential home network and the Internet.

The present invention generally relates to the field of communication between computer networks and more particularly to the interface between two computer networks. The present invention furthermore relates to a method, interface device and system of computing devices for enabling starting of sessions from a first computational device communicating via a first network having a first addressing realm to a second computational device on a second network having a second addressing realm as well as to a computer program product and a computer program element including program code for performing said method.

In the field of addressing in computer systems, there is normally a shortage of available public addresses to be used by different devices. This has led to many local systems having only one or a few public addresses used for the whole local system and then the local system will communicate with a global network via a gateway controlling these few addresses. Normally such a gateway will in this case be using a local addressing system for communicating with the devices in the local network.

In order to initiate sessions from such devices within a local network with other devices via a global network, the gateway is normally provided with a NAT (Network Address Translation) unit, which translates the local address to a global address for the communication with the other devices. A device within the local network can then start a session with a device outside the local network and the NAT unit would then set up an entry in the NAT table for such sessions, indicating how addresses are to be translated in order for the two devices to communicate with each other. There is however one problem with these kind of known NAT units, in that they do not allow communication sessions to be started from a device outside the local network, but only from inside the local network. There is a need for being able to start sessions from outside, for instance when doing peer-to-peer networking, where at least one side has to be able to accept incoming sessions.

The Internet Society describes one method of starting sessions from a global network to a device within a local network in RFC 2694 by P. Srisuresh, G. Tsirtsis, P. Akkiraju and A. Heffernan, September 1999. Here a gateway, which is an interface between the local network and the global network, has a number of addresses that can be used in the global network. The gateway also includes a NAT unit and a DNS_ALG (Domain Name Service Application Level Gateway) unit and the local network also includes a DNS server. When a device on the global network wants to start a session, it sends a recursive name query, which eventually reaches the gateway. The gateway forwards this query to the DNS server, which returns a local address of a local device associated with the queried name to the gateway. The gateway binds one of its global addresses to the local address and returns the global address as an answer to the query. The device on the global network can then start a session with this global address and the gateway immediately knows which device communication is intended for because of the binding. There are a few problems with this solution and that is that one global address is reserved for each session. If there are many parallel sessions to one or more devices on the local network, there have to be many global addresses available for the gateway, which is normally a shortage in present day systems. If the local network only has one address, this one address will be tied up to one session and there is no possibility for more inbound sessions.

Another approach is described in WO-0215014. Here an external device receives the address of the gateway for a local network via a DNS server and then contacts the gateway, which returns a local address of the device to be contacted to the external device. The external device can then start a session by communicating with the gateway using the gateway's address and the local address. There is also described how the gateway can be able to return the local address and that is by having a table mapping a domain name to local addresses and the above mentioned contact would then include the domain name of the local device. Here there is a lot of special functionality needed in the external device in order to start a session. The external device also has to communicate at least two times with the gateway before a session can be started.

It is an object of the present invention to provide a mechanism by which more than one session can be started from devices via a first network having a first addressing realm to devices in a second network, which mechanism is transparent to the devices communicating via the first network, i.e. they do not have to have any real knowledge of how they communicate with devices in the second network, while at the same time only needing one address for the whole second network in the first addressing realm.

According to a first aspect of the invention, this object is obtained by a method of enabling starting of sessions from a first computational device communicating via a first network having a first addressing realm to a second computational device on a second network having a second addressing realm, comprising the steps of:
receiving a name query concerning the second device and including a first address of the first addressing realm associated with the first device,
binding the received first address to a second address of the second addressing realm belonging to the second device, and
answering the query with a message comprising a third address of the first addressing realm belonging to an interface between the first and second networks, such that a session can be started from the first network.

According to a second aspect of the invention, this object is also achieved by an interface device and a system of computing devices including an interface device for connection of the interface device between a first network having a first addressing realm and a second network having a second addressing realm enabling starting of sessions from a first computational device communicating with the interface device via the first network to a second computational device in the second network, comprising:
a first input to be connected to the first network for receiving a name query concerning the second device, which query includes a first address of the first addressing realm associated with the first device,
a first output for connection to the first network,
an inbound session table, and
a control unit arranged to:
   bind the received first address to a second address of the second addressing realm belonging to the second device,
   store the first and second addresses in the inbound session table,
   generate an answer to the query as a message comprising a third address of the first addressing realm belonging to the interface device, and
   send the answer from the first output, such that a session can be started from the first device to the second device.

According to a third aspect of the invention, the object is also achieved by a computer program code and a computer program product comprising a computer readable medium to be used on a computer connectable between a first network having a first addressing realm and a second network having a second addressing realm, wherein a first computational device can communicate with the computer via the first network and the second network comprises a second computational device, said computer readable medium having thereon:
computer program code means, to make the computer execute, when said program is loaded in the computer:
upon reception of a name query from the first computing device concerning the second computing device and including a first address of the first addressing realm associated with the first computing device,
binding the received first address to a second address of the second addressing realm belonging to the second device, and
answering the query with a message comprising a third address of the first addressing realm belonging to the computer, such that a session can be started from the first device to the second device.

Another object is to enable several parallel sessions between a first device communicating via the first network and a second device in the second network.

According to a fourth aspect of the invention, this object is obtained by the features defined in claims 4 and 11.

Another object is to enable use of Domain Name Security Extensions (DNSSEC) when resolving names associated with inbound sessions.

According to a fifth aspect of the invention, this object is achieved with the features of claim 9.

The present invention has the advantage of allowing several parallel sessions with different devices in the second network started from the first network even though only one address in the first addressing realm is used for the second network. It also allows peer-to-peer networking. The invention has the further advantage of making it possible to provide such services as software upgrades to a large number of devices on the second network easily and transparently, without the devices on the second network having to send requests for updates. They also do not need to hard-code the address of the server doing the updating.

The general idea behind the invention is thus to bind a first address associated with a first device of a first network to a second address of a second device in a second network upon reception of a name query from the first device, which query includes the first address. A response to the name query is then sent including a third address belonging to an interface device provided between the two networks.

These and other aspects of the invention will be apparent from and elucidated with reference to the embodiments described hereinafter.

The present invention will now be explained in more detail in relation to the enclosed drawings, where

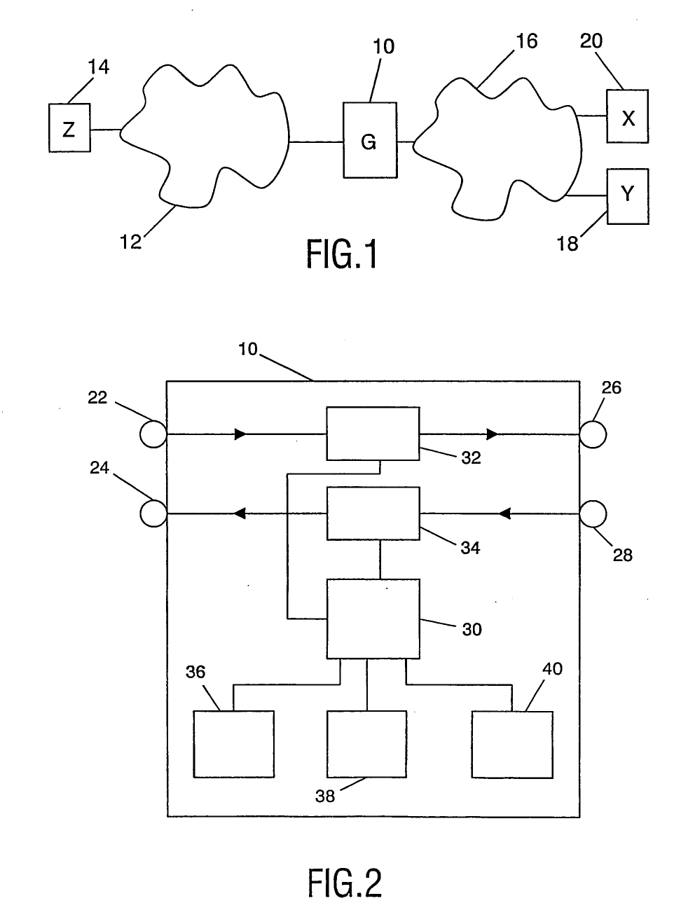

FIG. 1 shows a schematic drawing of a first network connected to a second network via a gateway according to the invention,

FIG. 2 shows a block schematic of the gateway according to the present invention,

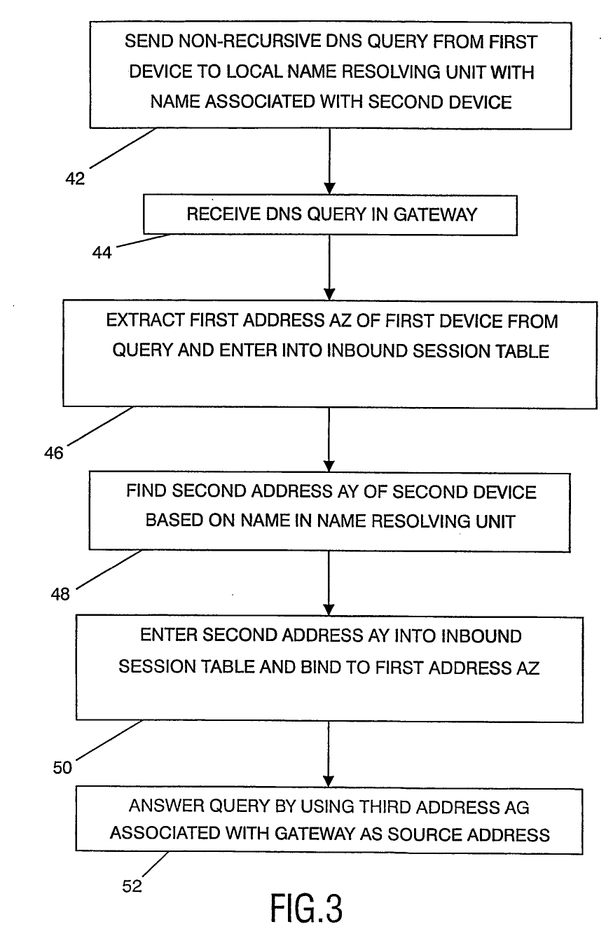

FIG. 3 shows a flow chart of a method of initiating a session from the first network to the second network according to the invention,

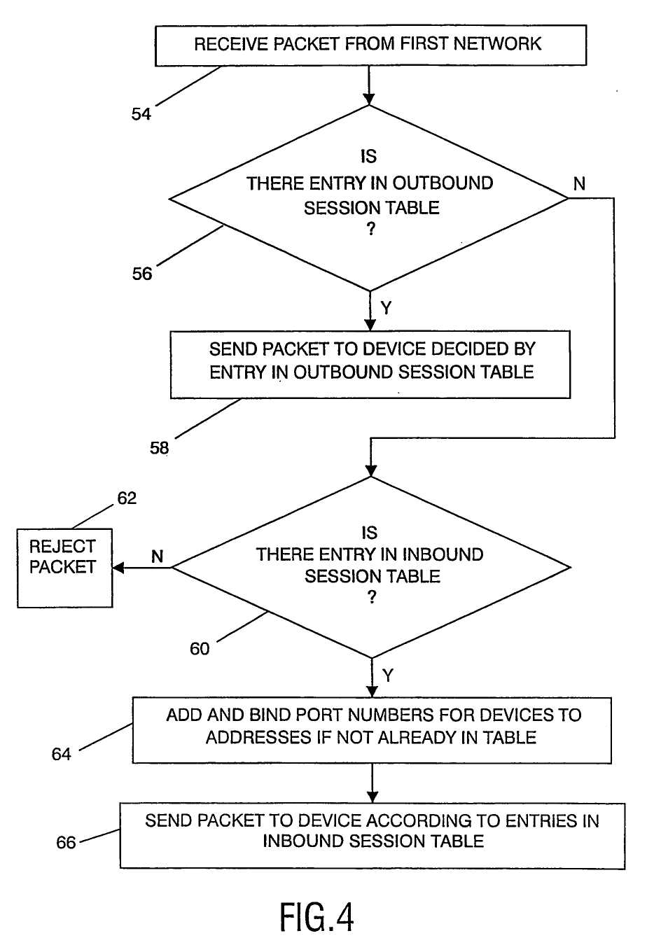

FIG. 4 shows a flow chart of a method of handling data packets arriving at the gateway sent from the first network,

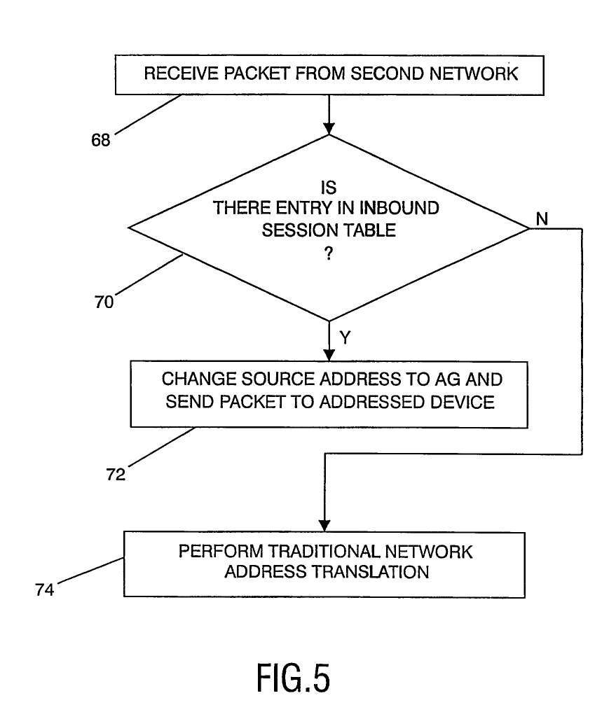

FIG. 5 shows a flow chart of a method of handling data packets arriving at the gateway sent from the second network,

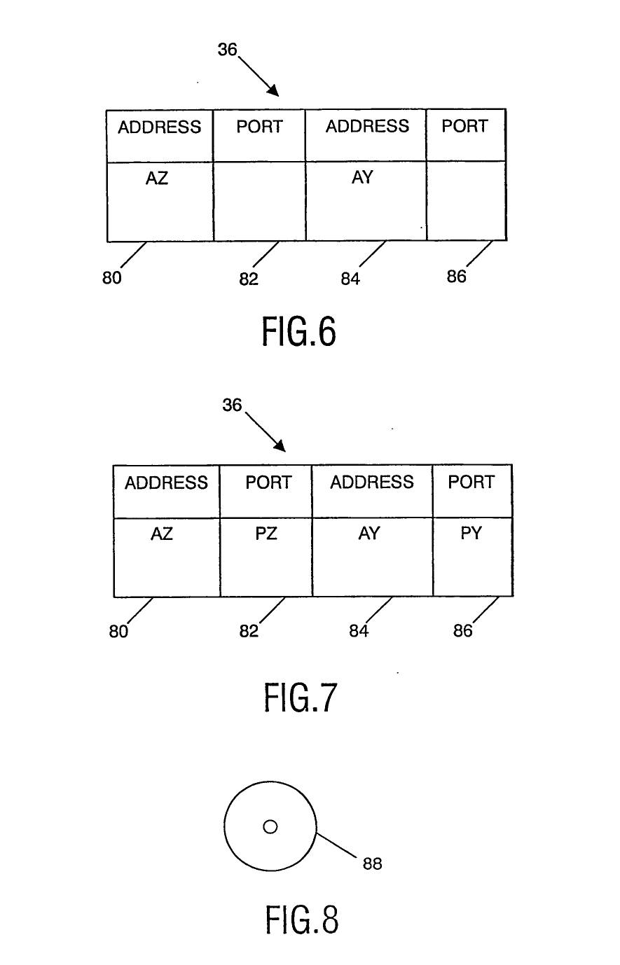

FIG. 6 schematically shows the contents of an inbound session table when a session is set up,

FIG. 7 schematically shows the contents of the inbound session table after a first packet has been received from the Internet in an inbound session, and

FIG. 8 schematically shows a computer readable medium on which is stored program code for performing the method according to the invention.

FIG. 1 shows a schematic drawing of the invention and it's environment. In FIG. 1 there is shown an interface device 10 according to the invention connected to a first network 12, which in this case is the Internet. A first computational device 14 is connected to the first network 12. The interface device, which in the preferred embodiment is a gateway 10 is also connected to a second network 16, which network includes a second and a third computational device 18 and 20. The first network 12 has a first addressing realm and the second network has a second addressing realm. The first addressing realm is here an IP-addressing realm, for instance IPv4, and used globally, while the second addressing realm is a local addressing realm used inside the second network 16. This second addressing realm is normally also using IP-addressing. The second network 16 is in the preferred embodiment a private home network. It should however be realized that the invention is not limited to private home networks, but can also be used for example in a corporate network. The first computational device 14 is also denoted Z, the second computational device 18 denoted Y, the third computational device 20 denoted X and the gateway 10 denoted G. The different devices thus have different addresses in the different realms. The first device 14 has an address AZ in the first addressing realm, the gateway has a third address AG in the first addressing realm, while the second device 18 has a second address AY in the second addressing realm and the third device 20 has a fourth address AX in the second addressing realm. It should be noted that the gateway 10 also has an address in the second addressing realm, but this will not be further described here, since this address is no essential part of the present invention. The second and third devices 18, 20 can be regular computers, but are not limited to this. They can be other computational devices as well such as Internet Radios, printers, scanners or any other type of computer equipment which can be connected in computer networks using an address. It should also be realized that there might be more or fewer devices in the second network 16. The first device 14 might for instance similarly be a server or any other suitable device, which can be connected to the Internet 12. It should also be realized that the first device 14 might be a device on a private or local network communicating with the Internet via a gateway. It is here shown as a device connected directly to the Internet in order to better explain the invention.

A simplified version of the gateway 10 according to the invention is shown in a block schematic in FIG. 2. The gateway 10 has a first input 22 connected to the Internet for reception of data packets and a first output 24 also connected to the Internet for sending of data packets. The gateway also has a second output 26 connected to the second network for sending of data packets and a second input 28 also connected to the second network for reception of data packets. A first register 32 is connected between the first input 22 and the second output 26, while a second register 34 is connected between the second input 28 and the first output 24. The directions the data packets are travelling are indicated with arrows. The first and second registers 32 and 34 are both connected to a control unit 30, which control unit 30 is connected to an inbound session table 36, to an outbound session table 38 and to a name resolving unit 40. An inbound session table is a table used for sessions started outside of the second network, i.e. for sessions started by devices in the first network that want to communicate with devices in the second network, while the outbound session table is used for sessions started from inside the second network with devices in the first network. The name resolving unit 40 is a server with DNS (Domain Name Service Capabilities), i.e. it maps a domain name to an address and here to an address in the second addressing realm.

FIGS. 3, 4 and 5 show different flow charts according to the invention describing how the invention works, which will be described in more detail later on, while FIG. 6 shows the inbound session table 36 after a session has been initiated but before any packets have been received. Each row of the table is dedicated to an ongoing session or a session that has just been initiated. For simplicity only one row or session is shown here, although it should be realized that there can be several rows for sessions between different devices and actually several rows for different sessions between the same two devices. A first column 80 is used for the addresses of devices in the first network having or initiating a session and here is shown the first address AZ of the first device. A second column 82 is used for port numbers associated with the address of the first network, which column is left blank here, because a session has not yet been started. A third column 84 is intended for the address of devices in the second network involved or to be involved in sessions, which column here shows the second address AY of the second device, while a fourth column 86 is intended for port numbers used in relation to the addresses on the second network, which column is here blank, because a session has not yet been started. FIG. 7 shows the same column as FIG. 6 but here port numbers have been filled in because a session is ongoing. The second column 82 has here received a first port number PZ associated with the first address AZ of the first device, while the fourth column 86 has received a second port number PY associated with the second address AY of the second device. These setting have been made after a first data packet has been received from the Internet by the gateway.

Now a first part of the invention will be described with reference being made to FIGS. 1, 2, 3 and 6.

The first device 14 sends a non-recursive name query to the first gateway 10 in order to get an address for communicating with the second device 20, step 42. This means that a recursive bit in the query has been cleared. This query is more particularly directed towards the name resolving unit 40 of the gateway 10. This query includes the domain name associated with this second device 20. Since the query is a non-recursive query, it comprises the first address of the first device. This name query has most probably been preceded by a number of previous name queries sent to other DNS servers in the first network 12. For each such DNS server contacted with the query, that server has indicated to the first device 14 a DNS server at a lower hierarchical level. In this way the first device queries a number of DNS servers until it directly contacts the gateway 10, which includes the name resolving unit 40 mapping the name of the second device 20 to an address. The gateway 10 then receives the DNS query, step 44, on the first input 22 and stores it in the first register 32. Then control unit 30 extracts the first address AZ from the query and stores it in the first column 80 of the inbound session table 36, step 46. Thereafter the query is forwarded to the name resolving unit 40, which finds the second address AY of the second device 18 for the name, step 48, and returns a response to the query to the control unit 30. The response also has the time-to-live field set to zero. Name resolving is performed according to well-known principles normally used in DNS servers. This is for instance described by P. Mockapetris in RFC 1034, November 1987, which is herein incorporated by reference. The response to the query here includes the second address AY, which the control unit 30 enters in the third column 84 of the inbound session table 36 and binds to the first address AZ, step 50. The control unit then replaces the second address AY with the third address AG associated with the gateway as source address in the reply and puts the thus changed reply or message in the second register 34, from where the message is sent to the first device 14 via the first output 24, step 52. This can also be seen as the control unit generating an answer to the query. The first device will now receive a response on the name query, which points out the gateway 10 instead of second device 20 as being associated with the name of device 20. The first device can now start a session using the third address AG as destination address. The first device 14 thus sends one query to the gateway 10 and can immediately start the session upon receipt of the reply, which reply can be provided in one single data packet. The first device 14 thus does not need to communicate with the gateway 10 more than once before starting the session. However the gateway will know that data packets are intended for the second device because of the settings made in the inbound session table. How this takes place will be described next.

Now a second part of the invention relating to the handling of data packets coming from the Internet 12 to the gateway 10 will be described in relation to FIGS. 1, 2, 4 and 7. First it has to be pointed out that the outbound session table 38 can be filled with information about outbound sessions, i.e. sessions started by devices 18 and 20. This information normally includes information such as address and port number of a device in the first network, address and port number of the device in the second network starting the session, and port number of the gateway. This table is a traditional NAT (Network Address Translation) table. How this type of table works is for instance described by The Internet Society in RFC 3022 by P Srisuresh and K Egevang, January 2001, which is hereby incorporated by reference. Thus the gateway 10 has to take care of both inbound sessions and outbound sessions.

The gateway receives packets from the first network 12 on the first input 22, which packets are stored in the first register 32, step 54. The control unit 30 then examines the data packet and first looks in the outbound session table 38 if there are any entries made for the data packet or not, step 56. If there are the data packet is sent from the first register 32 via the second output 26 to the device on the second network 16 obtained by address translation according to settings in that table 38, step 58. If there are no entries in that table 38, step 56, the control unit 30 goes on to check if there is an entry in the inbound session table 36, step 60, and if there are no entries there, the packet is rejected, step 62. In the example given above the data packet is a first data packet in the session initiated by the first device 14. Therefore there is an entry in said table 36, step 60, i.e. the table includes the first address AZ and the second address AY, of which the first address is also included in the received data packet. Therefore the control unit 30 looks at the port numbers used in the data packet. The control unit then enters and binds the port numbers used to the addresses in the inbound session table 36, if there were no port numbers already entered in said table, step 64. Here the first port number PZ associated with the first address AZ is entered into the second column 82 and the second port number PY associated with the second address AY is entered into the fourth column 86. Thereafter the control unit 30 changes the third address AG used in the data packet to the second address AY picked from table 36, leaves the port numbers unchanged and sends the data packet from the first register 32 to the second device 18 in the second network 16 via the second output 26, step 66. The first device 14 believes it uses a second port number associated with the gateway address AG, but since the gateway 10 is only part of a transport mechanism between the first and second devices 14, 18, it does not change the port number associated with the third address AG but keeps the same port number for the use with the second address AZ. For consecutive data packets in the same session started from the first device 14, the table 36 will not be updated further, but the address translation will take place in above described manner.

Now the handling of outbound data packets will be described in relation to FIGS. 1, 2, 5 and 7. The gateway 10 will receive a data packet on the second input 28 from the second network 16, which is then transferred to the second register 34, step 68. The control unit 30 will examine addresses and port numbers in the data packet and first look in the inbound session table 36 and see if there was an entry there for the data packet, step 70. In case there was, the data packet will include the destination address and the address of the device on the second network 16 as well as related port numbers. In the example given above in relation to the session started from the first device 14 to the second device 20, the data packet would contain destination address AZ and port number PZ as well as source address AY and port number PY. The control unit 30 will find the session information from the inbound session table and replace the source address AY of the data packet with the gateway address AG and then send the data packet on the first output 24 to the destination device 20, step 72. If there was no entry, step 70, then the control unit proceeds with traditional network address translation, step 74. This means that the control unit 30 checks the outbound session table 38 and forwards packets according to the entries made in that table 38 if there are entries and if there are no entries a new entry is made according to the principles set out in RFC 3022, the address is translated according to the settings and then sent out to the destination device.

Sessions can be ended in two ways. In case of TCP traffic a session is explicitly ended by information in the data packets. However in the case of UDP traffic there is no concept of a ‘session’ at the network layer and thus no way of knowing when the last data packet has arrived. Here a time-to-live field can be added to the inbound sessions table, containing a value on the length allowed for a session. This time-to-live value is provided as a sufficiently large value such that a time-out function using the value as a starting value does not end ongoing sessions prematurely. After this time-to-live value has expired in the time-out function, the entry is then cleared from the table.

The different units in the gateway are normally provided in the form of one or more processors together with suitable program memory containing appropriate program code for performing the method according to the invention. The tables are also normally provided in the form of memories. The software or program code for performing this can also be provided on a computer program product in the form of a computer readable medium, which will perform the method according to the invention when loaded into the gateway, which is in fact a sort of computer. One such medium in the form of a CD Rom 88 is depicted in FIG. 8, although there are many different mediums possible such as diskettes. The program code can also be downloaded remotely from a server outside the second network.

It should also be understood that the gateway described could include several more registers in the form of different input, output and buffer registers. The numbers have intentionally been kept low for getting a better understanding of the invention.

The present invention thus provides a possibility to initiate sessions from outside the second network without the first device knowing that it is setting up a session with a device having an address in another addressing realm, while at the same time only needing one address in the first addressing realm for the second network and still allowing several inbound sessions. This does not mean that the gateway must have only one address in the first addressing realm, but it can have several such addresses. The present invention thus allows peer-to-peer networking, such that the first and second devices can both act as clients and servers and have both inbound and outbound sessions.

The port numbers used for inbound sessions are well known and registered port numbers while the outbound sessions preferably use dynamic and/or private ports. In this way there is no risk for interference between inbound and outbound sessions. By using port numbers in the inbound session table it is possible to have several different inbound sessions ongoing between two devices. In addition to this it is also possible to have several inbound sessions with other devices on the internal network. By using well known registered port numbers it is furthermore possible to provide such services as software upgrades to a large number of devices on the second network easily and transparently, without the devices on the second network having to send requests for updates. They also do not need to hard-code the address of the server doing the updating. This also makes it possible to let any server send updates at any time. In this case authentication of an update has to be made by other means than just the server address.

The way addresses and ports are used according to the present invention also makes the gateway invulnerable to a type of denial of service attacks described in RFC 2694, where a malicious user keeps resolving the host name of an internal host without setting up a session and thereby blocking access to all internal hosts for all other users.

It is also possible to do a port number translation for the inbound session table. However, then many of the advantages associated with specialized port numbers will be lost.

In the preferred embodiment the name resolving unit is part of the gateway. This has the further advantage in that Domain Name Security Extensions (DNSSEC), can be used. Such extensions are described in RFC 2535—Domain Name Security Extensions, by D. Eastlake, March 1999, which is herein incorporated by reference. With these extensions the first device on the first network can trust that the answers to its hostname queries are valid as they are authenticated by the name resolving unit in the gateway.

In an alternative embodiment, the name resolving unit can be a separate entity on the second network with which the gateway would communicate in order to resolve the name. Then this DNSSEC feature would not be possible to use though.

The name resolving process can furthermore take place in the following way in a dynamic addressing environment. The name resolving unit is authoritative for the zone inside the second network. Requests for translation of names or hostnames belonging to that zone must be properly delegated to it by other DNS servers. Suppose that the second network is connected to an Internet Service provider (ISP). This ISP delivers the public address to the gateway of the second network. The ISP also has a DNS server and it updates this server to refer to this public address for queries of hostnames inside a zone formed by the customer's name, i.e. a name for the second network, and the ISPs domain name. If for example the customer is known as john1234 by the ISP and the ISP has the name isp1234, whenever the residential gateway of john1234 receives a public address from the ISP isp1234, the DNS servers authoritative for the zone isp1234.com will delegate queries for the sub zone john1234.isp1234.com to the name resolving unit of the residential gateway found at the public address just delivered. When a device on the first network then non-recursively queries the address of the second device, device Y, on that home network, called devicey.john1234.isp1234.com, the query will be delegated by the DNS server of zone isp1234.com to the DNS server of zone john1234.isp1234.com on the residential gateway, i.e. to the name resolving unit in the gateway of the second network.

An advantage of the Domain Name Security Extensions (DNSSEC) combined with the above-described name resolving process is that specialized services can be guaranteed. If the first device is a server, it can then maintain a list of hostnames of devices belonging to customers that would have paid a subscription for the services it delivers (like for example wake-up calls, personalized news-feeds, personalized streaming of video and audio). The server would then send queries for those hostnames and the name resolving unit in the gateway belonging to the customer would reply to those queries. Since these replies are authenticated (DNSSEC), the server is assured that it is sending the information to a device belonging to the real customer and not to a hacker pretending to be that customer.

Because of the setting of the time-to-live field to zero in the responses to name queries that the name resolving unit generates, the first device will not put the answer in a local cache but will reiterate the non-recursive request every time it tries to establish a new connection. This serves two purposes. It allows the creation of a new entry in the inbound session table for each new connection made by the first device (since a new request will arrive at the gateway) and if the address of the gateway changes (for instance because the ISP has delivered a different one in a dynamic addressing environment) the first device will not be using the old address that would have been kept in its local cache.

The present invention thus provides a system, an interface device, a method, a program product and program code, which facilitates initiation of sessions from a first network to a second network.

There are a number of possible variations to the invention, which can be made in addition to those already mentioned. The invention is not limited to IP-addressing, but other types of addressing are also possible. The entries of port numbers into the inbound session table can also be omitted, but then several parallel sessions between the same two devices is not possible. The original query can also be recursive, but then there must be provided ways of notifying the gateway about the address of the querying device.

The networks do also not need to be fixed networks, but can also for instance be wireless networks.

The invention is thus only to be limited by the following claims.

1. Method of enabling starting of sessions from a first computational device communicating via a first network having a first addressing realm to a second computational device on a second network having a second addressing realm, comprising the steps of:
receiving a name query concerning the second device and including a first address of the first addressing realm associated with the first device,
binding the received first address to a second address of the second addressing realm belonging to the second device, and
answering the query with a message comprising a third address of the first addressing realm belonging to an interface between the first and second networks, such that a session can be started from the first network.

2. Method according to claim 1, further including the steps of providing the second address as a result of the name query and replacing the second address with the third address before performing the step of answering the query.

3. Method according to claim 1, further including the step of receiving a first data packet from the first device comprising the third and the first address, changing the third address into the second address based on the previously made binding and forwarding the packet to the second device as a first data packet of the session.

4. Method according to claim 3, wherein the first data packet includes a first port number related to the first address and a second port number associated with the third address and further comprising the step of binding the first and second port numbers to the previously bound first and second addresses and forwarding the packet to the second device, while retaining the first and second port number.

5. Method according to claim 3, wherein the third address is changed to the second address and the second address is changed to the third address for all data packets sent from the first to the second device and from the second to the first device, respectively, during the session.

6. Method according to claim 5, further including the step of checking if received packets belong to a session started from a device on the second network and if they do translate addresses according to bindings made for that type of session and otherwise forward packets according to bindings made for a session started from outside the second network.

7. Method according to claim 1, further including the step of sending a non-recursive name query from the first device to the second network.

8. Interface device for connection between a first network having a first addressing realm and a second network having a second addressing realm enabling starting of sessions from a first computational device communicating with the interface device via the first network to a second computational device in the second network, comprising:
a first input to be connected to the first network for receiving a name query concerning the second device, which query includes a first address of the first addressing realm associated with the first device,
a first output for connection to the first network,
an inbound session table, and
a control unit arranged to:
bind the received first address to a second address of the second addressing realm belonging to the second device,
store the first and second addresses in the inbound session table,
generate an answer to the query as a message comprising a third address of the first addressing realm belonging to the interface device, and
send the answer from the first output, such that a session can be started from the first device to the second device.

9. Interface device according to claim 8, further including a name resolving unit arranged to receive the name query and provide the second address as a result of the name query to the control unit.

10. Interface device according to claim 8, wherein the first input can receive a first data packet from the first device comprising the third and the first address as a first data packet of the session and the control unit is arranged to change the third address to the second address based on the previously made bindings in the inbound session table and initiate forwarding of the packet to the second device.

11. Interface device according to claim 10, wherein the first data packet includes a first port number related to the first address and a second port number associated with the third address and the control unit is further arranged to bind the first and second port number to the previously bound first and second addresses and to forward the packet to the second device while retaining the first and second port numbers.

12. Interface device according to claim 10, wherein the control unit is arranged to change the third address to the second address and the second address to the third address in all data packets sent from the first to the second device and from the second to the first device, respectively, during the session.

13. Interface device according to claim 12, further including an outbound session table and wherein the control unit is further arranged to check if received packets belong to a session started from a device on the second network in the outbound session table and if they do translate addresses according to bindings made in that table and otherwise forward packets according to bindings made in the inbound session table.

14. System of computing devices for connection to a first network having a first addressing realm, via which first network a first computational device can communicate with the system and comprising a second network having a second addressing realm, said second network comprising:
a second computational device, and
an interface device provided between the first and second networks comprising:
a first input to be connected to the first network for receiving a name query concerning the second device, which query includes a first address of the first addressing realm associated with the first device,
a first output for connection to the first network,
an inbound session table,
a control unit arranged to:
bind the received first address to a second address of the second addressing realm belonging to the second device,
store the first and second addresses in the inbound session table,
generate an answer to the query as a message comprising a third address of the first addressing realm belonging to the interface device, and
initiate sending of the answer from the first output, such that a session can be started from the first device to the second device.

15. System of computing devices according to claim 14, further comprising the first computational device, which is arranged to send a non-recursive name query to the second network.

16. Computer program product comprising a computer readable medium to be used on a computer connectable between a first network having a first addressing realm and a second network having a second addressing realm, wherein a first computational device can communicate with the computer via the first network and the second network comprises a second computational device, said computer readable medium having thereon:
computer program code means, to make the computer execute, when said program is loaded in the computer:
upon reception of a name query from the first computing device concerning the second computing device and including a first address of the first addressing realm associated with the first computing device,
binding the received first address to a second address of the second addressing realm belonging to the second device, and
answering the query with a message comprising a third address of the first addressing realm belonging to the computer, such that a session can be started from the first device to the second device.

17. Computer program element to be used on a computer connectable between a first network having a first addressing realm and a second network having a second addressing realm, wherein a first computational device can communicate with the computer via the first network and the second network comprises a second computational device, said computer program element comprising:
computer program code means, to make the computer execute, when said program is loaded in the computer:
upon reception of a name query from the first computing device concerning the second computing device and including a first address of the first addressing realm associated with the first computing device,
binding the received first address to a second address of the second addressing realm belonging to the second device, and
answering the query with a message comprising a third address of the first addressing realm belonging to the computer, such that a session can be started from the first device to the second device.
